(19) United States
(12) Patent Application Publication
(10) Pub. No.: US 2025/0390216 A1
(43) Pub. Date: Dec. 25, 2025

(54) REMOTE MONITORING METHOD, REMOTE MONITORING DEVICE, AND RECORDING MEDIUM

(71) Applicant: Panasonic Intellectual Property Management Co., Ltd., Osaka (JP)

(72) Inventors: Motoshi Anabuki, Hyogo (JP); Shunsuke Kuhara, Osaka (JP); Yoshimasa Honda, Hyogo (JP)

(21) Appl. No.: 19/317,464

(22) Filed: Sep. 3, 2025

Related U.S. Application Data
(63) Continuation of application No. PCT/JP2024/004896, filed on Feb. 13, 2024.
(60) Provisional application No. 63/452,506, filed on Mar. 16, 2023.

(51) Int. Cl. G06F 3/04886; G06F 3/041

(52) U.S. Cl. CPC G06F 3/04886; G06F 3/04166; G06F 2203/04803

(57) ABSTRACT

A remote monitoring method is a method for remotely monitoring a mobile body that travels autonomously. The remote monitoring method includes: displaying a first video that has captured a direction in which the mobile body is capable of moving; and enabling detection of a touch operation on a first region in which the first video is displayed.

### CROSS REFERENCE TO RELATED APPLICATIONS

This is a continuation application of PCT International Application No. PCT/JP2024/004896 filed on Feb. 13, 2024, designating the United States of America, which is based on and claims priority of U.S. Provisional Patent Application No. 63/452,506 filed on Mar. 16, 2023. The entire disclosures of the above-identified applications, including the specifications, drawings and claims are incorporated herein by reference in their entirety.

### FIELD

The present disclosure relates to a remote monitoring method, a remote monitoring device, and a recording medium.

### BACKGROUND

It is studied to remotely give an instruction for starting autonomous traveling or the like by a touch operation while watching a video, when remotely monitoring a mobile body that travels autonomously.

Therefore, it is desired that the operativity of touch operations be improved. For example, Patent Literature (PTL) 1 discloses a video monitoring system that can control the operation of a video recording device according to a touch gesture operation by an operator.

### CITATION LIST

### Patent Literature

PTL 1: Japanese Unexamined Patent Application Publication No. 2010-258878

### SUMMARY

### Technical Problem

Incidentally, in the remote monitoring of a mobile body, since the safety is checked by watching a video, it is desired to increase the proportion of the video that occupies a screen. Therefore, it is difficult to enlarge the display (for example, the button display) for instructions, such as an instruction for starting autonomous traveling, and there is room for improvement in the operativity of touch operations. PTL 1 does not disclose a technique capable of improving the operativity of touch operations in a case where it is difficult to enlarge the display.

Therefore, the present disclosure provides a remote monitoring method, a remote monitoring device, and a recording medium that can improve the operativity of touch operations over conventional techniques.

### Solution to Problem

A remote monitoring method according to an aspect of the present disclosure is a remote monitoring method for remotely monitoring a mobile body that travels autonomously, the remote monitoring method including: displaying a first video that has captured a direction in which the mobile body is capable of moving; and enabling detection of a touch operation on a first region in which the first video is displayed.

A remote monitoring device according to an aspect of the present disclosure is a remote monitoring device that remotely monitors a mobile body that travels autonomously, the remote monitoring device including: a first controller that controls displaying of a video that has captured a direction in which the mobile body is capable of moving; and a second controller that enables detection of a touch operation on a region in which the video is displayed.

A recording medium according to an aspect of the present disclosure is a non-transitory computer-readable recording medium having recorded thereon a program for causing a computer to execute the remote monitoring method described above.

### Advantageous Effects

According to an aspect of the present disclosure, it is possible to realize a remote monitoring method and the like that can improve the operativity of touch operations over conventional techniques.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a schematic diagram illustrating a situation in which an operator performs remote monitoring.

FIG. 2 is a diagram illustrating an example of screens that are being checked by an operator.

FIG. 3 is a diagram illustrating the functional configuration of a remote monitoring system according to an embodiment.

FIG. 4 is a flowchart illustrating the display operation of a terminal according to an embodiment.

FIG. 5 is a diagram illustrating a display example of a terminal according to an embodiment.

FIG. 6 is a flowchart illustrating the execution operation of a terminal according to an embodiment.

FIG. 7 is a flowchart illustrating the display operation of a terminal according to Variation 1 of an embodiment.

FIG. 8A is a diagram illustrating a first example of the display of a terminal according to Variation 1 of an embodiment.

FIG. 8B is a diagram illustrating a second example of the display of a terminal according to Variation 1 of an embodiment.

FIG. 9 is a flowchart illustrating the display operation of a terminal according to Variation 2 of an embodiment.

FIG. 10 is a diagram illustrating a display example of a terminal according to Variation 2 of an embodiment.

FIG. 11 is a flowchart illustrating the operation of a terminal according to Variation 3 of an embodiment.

FIG. 12 is a diagram illustrating a display example of a terminal according to Variation 3 of an embodiment.

FIG. 13 is a flowchart illustrating the operation of a terminal according to Variation 4 of an embodiment.

FIG. 14 is a table showing the relationship between the operation type of a touch operation, the display style of video, and the execution command according to Variation 4 of an embodiment.

FIG. 15 is a diagram illustrating a display example of a terminal according to Variation 4 of an embodiment.

FIG. 16 is a flowchart illustrating the operation of a terminal according to Variation 5 of an embodiment.

FIG. 17 is a diagram illustrating an example of the vehicle state according to Variation 5 of an embodiment.

FIG. 18 is a flowchart illustrating an example of step S72 illustrated in FIG. 16.

FIG. 19 is a diagram illustrating a display example of a terminal according to Variation 5 of an embodiment.

FIG. 20 is a flowchart illustrating the operation of a terminal according to Variation 6 of an embodiment.

FIG. 21 is a table showing the relationship between the vehicle state and the execution command according to Variation 6 of an embodiment.

FIG. 22 is a diagram illustrating a display example of a terminal according to Variation 6 of an embodiment.

FIG. 23 is a flowchart illustrating the operation of a terminal according to Variation 7 of an embodiment.

FIG. 24 is a diagram illustrating a display example of a terminal according to Variation 7 of an embodiment.

FIG. 25 is a flowchart illustrating the operation of a terminal according to Variation 8 of an embodiment.

FIG. 26 is a diagram illustrating an example of route information according to Variation 8 of an embodiment.

FIG. 27 is a table showing the relationship between the route and the command assignment destination according to Variation 8 of an embodiment.

FIG. 28 is a diagram illustrating a display example of a terminal according to Variation 8 of an embodiment.

### DESCRIPTION OF EMBODIMENTS

### (Circumstances Leading to the Present Disclosure)

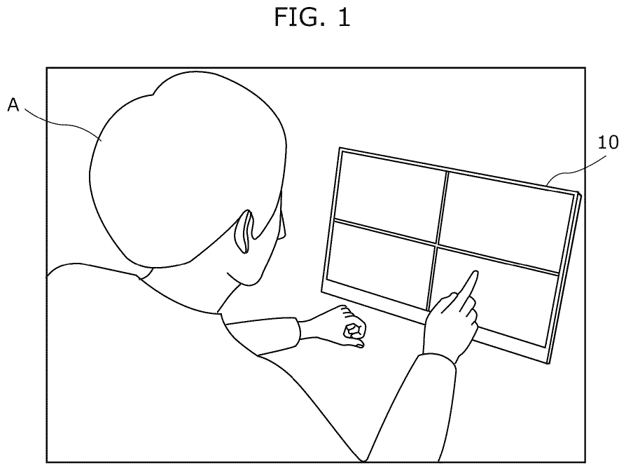

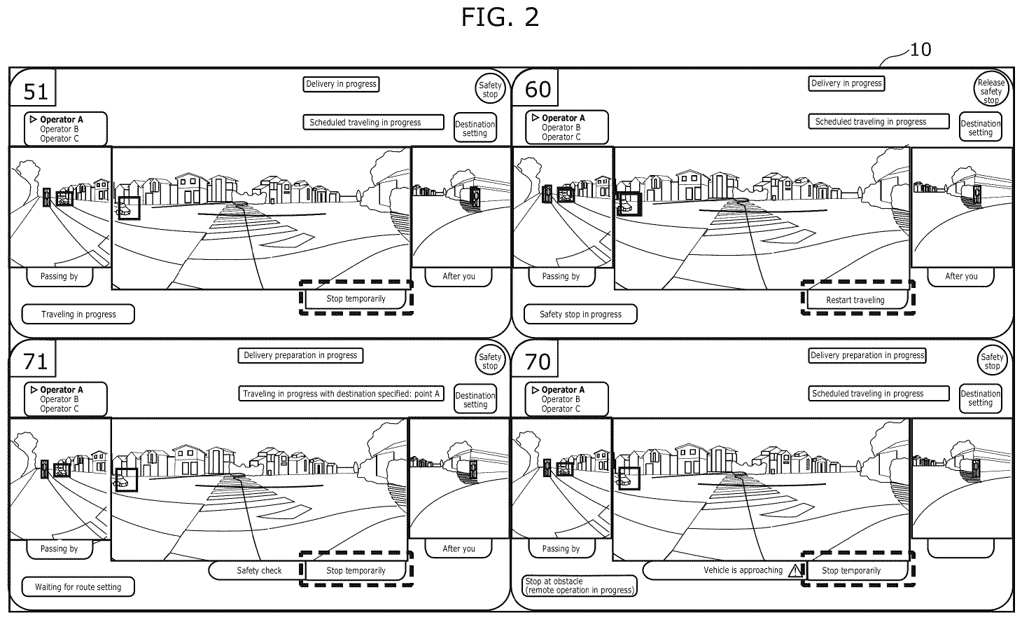

Before describing embodiments and the like of the present disclosure, the circumstances leading to the present disclosure will be described with reference to FIG. 1 and FIG. 2. FIG. 1 is a schematic diagram illustrating a situation in which operator A performs remote monitoring.

As illustrated in FIG. 1, operator A performs remote monitoring of a mobile body, while checking a video of the moving direction and the like of the mobile body displayed on terminal 10. Operator A performs, for example, remote monitoring of a plurality of mobile bodies. A mobile body is a mobile body that travels autonomously. Operator A performs remote monitoring of the mobile bodies that travel autonomously. Note that remote monitoring means that operator A monitors the state of a mobile body that moves autonomously by using a video that captures the vicinity of the mobile body, in a remote place from which the mobile body cannot be directly observed.

FIG. 2 is a diagram illustrating an example of screens that are being checked by operator A. FIG. 2 illustrates a display example of a display in a case where operator A is remotely monitoring four mobile bodies with mobile body IDs 51, 60, 70, and 71.

As illustrated in FIG. 2, the videos of the moving direction and the like of the mobile bodies (in the example of FIG. 2, three videos for the forward, left, and right directions) are displayed, and operation contents (commands) to be executed by the mobile bodies, such as stop temporarily and restart traveling, are displayed.

Operator A can give an instruction, such as stop temporarily or restart traveling, to the mobile bodies as needed, while performing remote monitoring. For example, when operator A presses an operation button (inside a broken line frame in FIG. 2) for stop temporarily that is presented on the periphery of a display region displaying the video of the mobile body with a mobile body ID of 51, operator A can cause the mobile body to stop temporarily.

An instruction given by operator A in remote monitoring is to permit an operation of a mobile body, or causing the mobile body to execute a predetermined operation. An instruction given by operator A in remote monitoring is executed by a simple operation such as touching an operation button, without using an input device such as a steering wheel. An instruction given by operator A in remote monitoring may be, for example, to permit a stationary mobile body to start traveling, or may be to permit a mobile body to stop temporarily since there is an obstacle ahead.

Here, there are problems that, since the safety is checked by watching a video, it is requested to maximize the proportion of the video that occupies a screen, and it is difficult to enlarge operation buttons on a screen and the operativity of touch operations is poor.

PTL 1 does not disclose a technique that can solve such problems.

Therefore, the present inventors conducted extensive studies on a remote monitoring method and the like that can improve the operativity of touch operations over conventional techniques, and invented a remote monitoring method and the like that are illustrated below.

A remote monitoring method according to a first aspect of the present disclosure is a remote monitoring method for remotely monitoring a mobile body that travels autonomously. The remote monitoring method includes: displaying a first video that has captured a direction in which the mobile body is capable of moving; and enabling detection of a touch operation on a first region in which the first video is displayed.

Accordingly, since the region in which the first video is displayed can be used as the region of an operation button, the region of the operation button can be increased. Therefore, it is possible to realize a remote monitoring method capable of improving the operativity of touch operations over conventional techniques.

In addition, for example, a remote monitoring method according to a second aspect of the present disclosure is the remote monitoring method according to the first aspect and may further include displaying, in the first region or the vicinity of the first region, an operation content to be executed through the touch operation on the first region.

Accordingly, the operation content can be displayed to the operator. The operativity of touch operation can be improved compared with a case where the operation content is not displayed.

In addition, for example, a remote monitoring method according to a third aspect is the remote monitoring method according to the first aspect and may further include displaying a frame surrounding the first region.

Accordingly, since an operation region in which detection of the touch operation is enabled is clearly indicated, a touchable region becomes clear, and the operativity of touch operations can be improved.

In addition, for example, a remote monitoring method according to a fourth aspect is the remote monitoring method according to the third aspect and may further include displaying, in the first region or the vicinity of the first region, an operation content to be executed through the touch operation on the first region. In the remote monitoring method, the frame and the operation content may be displayed in the same display style.

Accordingly, since the frame and the operation content are displayed in the same style, the touchable region and the operation content can become clearer. That is, the operativity of touch operations can be further improved.

In addition, for example, a remote monitoring method according to a fifth aspect is the remote monitoring method according to the fourth aspect, and in the remote monitoring method, the frame and the operation content may be displayed in the same color.

Accordingly, the frame and the operation content can be displayed in the same color.

In addition, for example, a remote monitoring method according to a sixth aspect is the remote monitoring method according to any one of the third through fifth aspects and may further include changing a display style of the frame when the touch operation on the first region is received.

Accordingly, with the display style of the frame, it is possible to notify the operator that the touch operation is received.

In addition, for example, a remote monitoring method according to a seventh aspect is the remote monitoring method according to any one of the third through sixth aspects and may further include changing a display style of the frame according to an execution state of the operation content intended for the mobile body.

Accordingly, with the display style of the frame, it is possible to notify the operator of the execution state of the command.

In addition, for example, a remote monitoring method according to an eighth aspect is the remote monitoring method according to the fourth aspect or the fifth aspect, and in the remote monitoring method, the detection of the touch operation on the first region may be switchable to be disabled, based on a state of the mobile body, and the remote monitoring method may further include making a display style of the operation content different depending on whether the detection of the touch operation on the first region is enabled or disabled.

Accordingly, it is possible to notify the operator whether the touch operation is enabled or disabled.

In addition, for example, a remote monitoring method according to a ninth aspect is the remote monitoring method according to any one of the third through eighth aspects, and in the remote monitoring method, the detection of the touch operation on the first region may be switchable to be disabled, based on a state of the mobile body, and the remote monitoring method may further include making a display style of the frame different depending on whether the detection of the touch operation on the first region is enabled or disabled.

Accordingly, it is possible to notify, with the display style of the frame, whether the touch operation is enabled or disabled.

In addition, for example, a remote monitoring method according to a tenth aspect is the remote monitoring method according to any one of the third through ninth aspects, and in the remote monitoring method, the detection of the touch operation on the first region may be switchable to be disabled, based on a state of the mobile body, and the remote monitoring method may further include making a display style of the first video different depending on whether the detection of the touch operation on the first region is enabled or disabled.

Accordingly, it is possible to notify, with the display style of the video, whether the touch operation is enabled or disabled.

In addition, for example, a remote monitoring method according to an eleventh aspect is the remote monitoring method according to any one of the first through tenth aspects and may further include switching an operation content associated with the first region, based on a state of the mobile body.

Accordingly, it is possible to automatically switch to a command according to the state of the mobile body.

In addition, for example, a remote monitoring method according to a twelfth aspect is the remote monitoring method according to any one of the first through eleventh aspects and may further include changing a display style of the first video when the touch operation on the first region is detected.

Accordingly, with the display style of the first video, it is possible to notify the operator that the touch operation is detected.

In addition, for example, a remote monitoring method according to a thirteenth aspect is the remote monitoring method according to any one of the third through tenth aspects and may further include changing a display style of the frame when the touch operation on the first region is detected.

Accordingly, with the display style of the frame, it is possible to notify the operator that the touch operation is detected.

In addition, for example, a remote monitoring method according to a fourteenth aspect is the remote monitoring method according to any one of the first through thirteenth aspects and may further include changing a display style of the first video according to an execution state of remote monitoring of the mobile body.

Accordingly, with the display style of the first video, it is possible to notify the operator of the execution state of the operation content.

In addition, for example, a remote monitoring method according to a fifteenth aspect is the remote monitoring method according to any one of the first through fourteenth aspects, and in the remote monitoring method, the first video may be a video that has captured a first direction in which the mobile body is capable of moving, and the remote monitoring method may further include: displaying, in a second region different from the first region, a second video that has captured a second direction in which the mobile body is capable of moving; obtaining route information on the mobile body; and enabling detection of the touch operation on the first region when a moving direction of the mobile body based on the route information is the first direction.

Accordingly, it is possible to automatically enable the detection of the touch operation on the video region according to the moving direction of the mobile body.

In addition, for example, a remote monitoring method according to a sixteenth aspect is the remote monitoring method according to any one of the first through fifteenth aspects, and in the remote monitoring method, the touch operation may include a plurality of operation types, and the remote monitoring method may further include making the operation content and a display style of the first video different according to an operation type of the touch operation executed on the first region.

Accordingly, it becomes possible to execute a plurality of display styles and commands only by changing the operation type.

In addition, a remote monitoring device according to a seventeenth aspect is a remote monitoring device that remotely monitors a mobile body that travels autonomously. The remote monitoring device includes: a first controller that controls displaying of a video that has captured a direction in which the mobile body is capable of moving; and a second controller that enables detection of a touch operation on a region in which the video is displayed. In addition, a recording medium according to an eighteenth aspect is a non-transitory computer-readable recording medium having recorded thereon a program for causing a computer to execute the remote monitoring method according to any one of the first through sixteenth aspects.

With these, effects similar to those in the above-described remote monitoring method can be achieved.

Note that these general and specific aspects may be implemented using a system, a method, an integrated circuit, a computer program, or a non-transitory computer-readable recording medium such as a compact disc read-only memory (CD-ROM), or any combination of systems, methods, integrated circuits, computer programs, or recording media. The program(s) may be stored in a recording medium in advance or may be supplied to a recording medium via a wide area communication network including the Internet, for example.

Hereinafter, exemplary embodiments and the like will be specifically described with reference to the drawings.

Note that each of the exemplary embodiments and the like described below shows a general or specific example. The numerical values, shapes, constituent elements, the arrangement and connection of the constituent elements, steps, the processing order of the steps etc. shown in the following exemplary embodiments are mere examples, and therefore do not intend to limit the present disclosure. Among the constituent elements in the following exemplary embodiments, those not recited in any one of the independent claims will be described as optional constituent elements.

The drawings are represented schematically and are not necessarily precise illustrations. Thus, the scales, for example, are not necessarily consistent from drawing to drawing. In the drawings, constituent elements that are substantially the same are given the same reference signs, and redundant descriptions will be omitted or simplified.

In the present specification, terms indicating a relationship between elements, such as “the same”, numerical values, and numerical value ranges do not express their strict meanings only, but also include substantially equivalent ranges, e.g., differences of several percent (or about 10%).

In the present specification, ordinal numerals such as “first” and “second” do not mean the number or order of constituent elements unless otherwise stated in particular. The ordinal numerals are used to avoid confusion of and distinguish between constituent elements of the same type.

### Embodiment

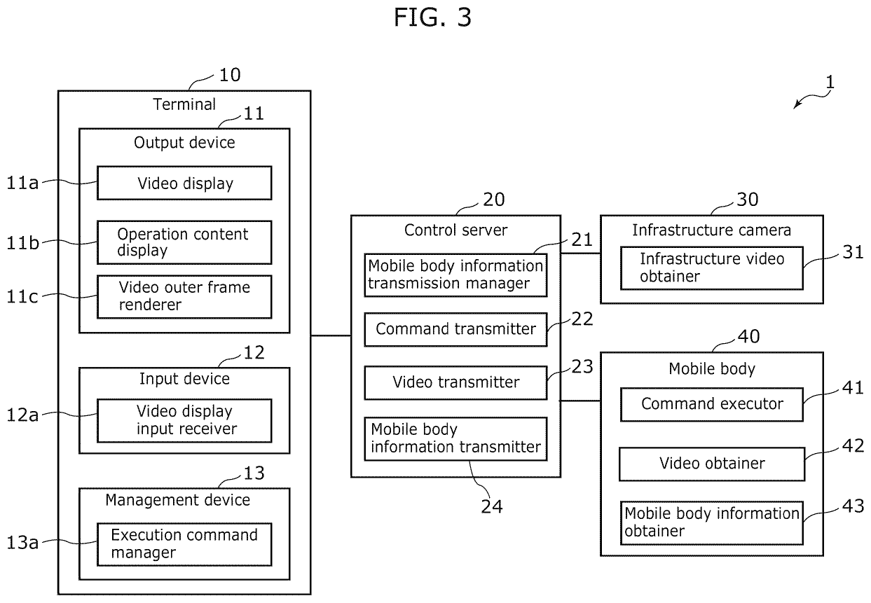

Hereinafter, a remote monitoring method and the like according to the present embodiment will be described with reference to FIG. 3 to FIG. 6.

### [1. Configuration of Remote Monitoring System]

First, referring to FIG. 3, a description will be given of the configuration of a remote monitoring system that executes the remote monitoring method according to the present embodiment. FIG. 3 is a diagram illustrating the functional configuration of remote monitoring system 1 according to the present embodiment.

As illustrated in FIG. 3, remote monitoring system 1 includes terminal 10. Remote monitoring system 1 further includes control server 20, infrastructure camera 30, and mobile body 40. For example, a plurality of infrastructure cameras 30 and mobile bodies 40 are included in remote monitoring system 1.

Terminal 10 is a terminal system used by an operator who remotely monitors mobile body 40 that travels autonomously, and is communicatively connected to control server 20. Terminal 10 is constituted by including computer devices. Specifically, terminal 10 is realized by a non-volatile memory in which a program is stored, a volatile memory that is a temporary storage region for executing the program, an input/output port, a communication interface, a processor for executing the program, a display such as a liquid crystal display device, and the like. In addition, terminal 10 includes output device 11, input device 12, and management device 13. Output device 11, input device 12, and management device 13 may be realized as an integrated device, or as mutually different devices that are communicatively connected to each other. Terminal 10 is an example of a remote monitoring device.

Output device 11 outputs (displays) information for the operator to perform remote monitoring. Output device 11 is constituted by including, for example, a display. In addition, output device 11 includes video display 11a, operation content display 11b, and video outer frame renderer 11c.

Video display 11a displays, to the operator, a video (an example of the first video) that has captured a direction in which mobile body 40 is capable of moving. The direction in which mobile body 40 is capable of moving includes, for example, a forward direction, a right-turn direction, a left-turn direction, and the like, when mobile body 40 moves forward. Video display 11a displays, to the operator, the video captured by at least one of a camera mounted on mobile body 40 or a camera arranged in the vicinity of mobile body 40. The video is for the operator to perform remote monitoring, and is desired to be displayed in a wide region on a screen. Video display 11a is an example of the first controller.

Operation content display 11b displays the type of an operation content (command) that is executed when a touch operation is performed on the video. A touch operation includes at least one of touching or clicking.

Video outer frame renderer 11c displays a frame indicating that it is an operation region, in the vicinity of the video displayed by video display 11a. Video outer frame renderer 11c may display, for example, the frame of a display style according to the operation content to be executed by mobile body 40. Video outer frame renderer 11c may display, for example, the frame including at least one of a color, a pattern, or a shape according to the operation content.

Note that it suffices if output device 11 includes at least video display 11a.

Input device 12 receives an input from the operator. Specifically, input device 12 receives a touch operation from the operator. Input device 12 includes video display input receiver 12a.

Video display input receiver 12a is arranged on the display region in which the video is displayed by video display 11a, and detects the touch operation by the operator. Video display input receiver 12a is constituted by including, for example, a touch panel and the like. The touch panel is arranged so as to cover, for example, a display panel that displays the video.

In the present embodiment, when the operator performs a touch operation on the display region of the video displayed by video display 11a, video display input receiver 12a detects the touch operation. It can be said that video display input receiver 12a enables the detection of the touch operation on the region (an example of the first region) of the screen of the display panel in which the video is displayed. Video display input receiver 12a is an example of the second controller.

Management device 13 manages which command is to be executed by mobile body 40 when the operator performs a touch operation. Management device 13 includes execution command manager 13a.

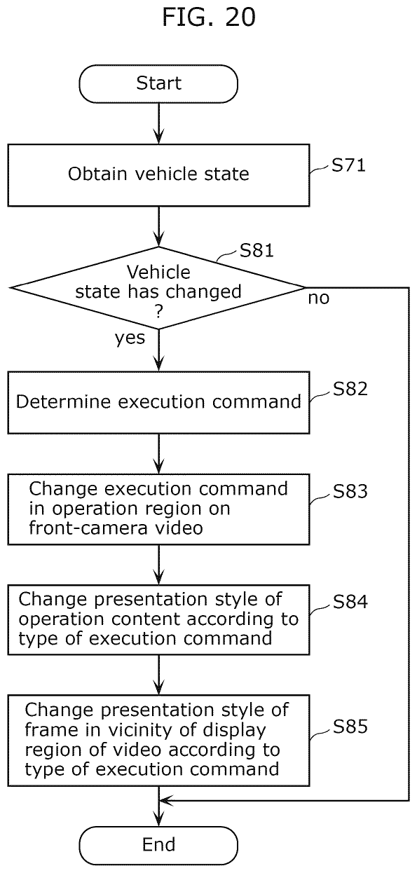

Execution command manager 13a may determine the command to be executed by mobile body 40 based on, for example, a table (refer to, for example, FIG. 21, which will be described later) in which the state of the mobile body (for example, the vehicle state) and the execution command are associated with each other.

Note that terminal 10 may include a storage (not illustrated) that stores the table for determining the command, and the like. The storage is realized by, for example, a semiconductor memory or the like, but is not limited to this.

Control server 20 is communicatively connected to terminal 10, infrastructure camera 30, and mobile body 40, and transmits and receives various information. Control server 20 is realized by computer devices. Specifically, control server 20 is realized by a non-volatile memory in which a program is stored, a volatile memory that is a temporary storage region for executing the program, an input/output port, a communication interface, a processor for executing the program, and the like. Control server 20 may be realized by, for example, a server device. In addition, control server 20 includes, as the functional configuration, mobile body information transmission manager 21, command transmitter 22, video transmitter 23, and mobile body information transmitter 24.

Mobile body information transmission manager 21 manages from which mobile body 40 or which infrastructure camera 30 the video is to be transferred (displayed) to which terminal 10, or from which terminal 10 the command is to be transmitted to which mobile body 40. Mobile body information transmission manager 21 manages a transmission destination based on, for example, a destination address, a transmission source address, and the like that are included in received information.

Command transmitter 22 transmits the command from terminal 10 to mobile body 40 that is specified based on mobile body information transmission manager 21.

Video transmitter 23 transmits the video from mobile body 40 or infrastructure camera 30 to terminal 10 that is specified based on mobile body information transmission manager 21.

Mobile body information transmitter 24 transmits the information indicating the state of mobile body 40 to terminal 10 that is specified based on mobile body information transmission manager 21.

Infrastructure camera 30 is a fixed or movable camera installed at a fixed point in the vicinity of a path along which mobile body 40 moves. Infrastructure camera 30 captures an obstacle and the like on the target path. Infrastructure camera 30 is communicatively connected to control server 20, and transmits the captured video to control server 20. Infrastructure camera 30 includes infrastructure video obtainer 31.

Infrastructure video obtainer 31 transmits the video from the camera installed at an infrastructure to control server 20. Infrastructure video obtainer 31 obtains the video captured by, for example, the camera of infrastructure camera 30 itself or the other infrastructure camera, and transmits the obtained video to control server 20. Infrastructure video obtainer 31 is constituted by including, for example, a communication interface.

Mobile body 40 is a mobile body that is capable of moving autonomously and that is to be remotely monitored by the operator. Mobile body 40 is not particularly limited as long as it is a mobile body capable of moving autonomously, and may be, for example, a vehicle (for example, an automobile, a railway, or the like) capable of traveling autonomously, a flying body (for example, a drone) capable of flying autonomously, a marine vessel capable of sailing autonomously, or the like.

Mobile body 40 is communicatively connected to control server 20. Mobile body 40 is constituted by including computer devices and the like. Specifically, mobile body 40 is constituted by including a non-volatile memory in which a program is stored, a volatile memory that is a temporary storage region for executing the program, an input/output port, a communication interface, a processor for executing the program, and the like. In addition, mobile body 40 includes, as the functional configuration, command executor 41, video obtainer 42, and mobile body information obtainer 43.

Command executor 41 receives a command from control server 20, and executes the received command. Command executor 41 controls the movement of mobile body 40 according to the command.

Video obtainer 42 obtains a video from one or more cameras installed in mobile body 40, and transmits the video to control server 20. Mobile body 40 includes a camera capable of capturing the front (forward direction), the left and right (lateral direction), the rear direction, and the like.

Mobile body information obtainer 43 obtains information such as the mode, vehicle speed, route, and the like of mobile body 40. The mode includes an autonomous moving mode and a remote monitoring mode (or a remote operation mode). The mode can be obtained from, for example, a mode controller or the like that is mounted on mobile body 40. The vehicle speed can be obtained from a speed sensor or the like that is mounted on mobile body 40. The route can be obtained based on destination setting by a user of mobile body 40.

### [2. Operation of Remote Monitoring System]

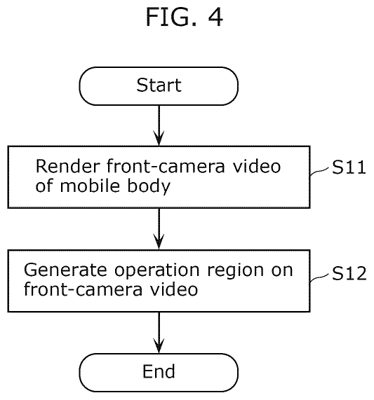

Subsequently, referring to FIG. 4 to FIG. 6, a description will be given of the operation of remote monitoring system 1 configured as described above. FIG. 4 is a flowchart illustrating the display operation (remote monitoring method) of terminal 10 according to the present embodiment. Although an example of displaying a front-camera video will be described with FIG. 4, a side camera video or the like may be displayed instead of the front-camera video. In addition, the operation illustrated in FIG. 4 is executed by terminal 10.

As illustrated in FIG. 4, video display 11a renders, on the display, the front-camera video of mobile body 40 to be remotely monitored by the operator (S11).

Next, video display input receiver 12a generates an operation region on the front-camera video (S12). It can be said that video display input receiver 12a enables the detection of the touch operation on the region in which the front-camera video is displayed. Accordingly, it is possible to turn ON the detection of the touch operation on the operation region by the operator, that is, the touch operation on the front-camera video. For example, the display region of the front-camera video and the operation region may overlap, and may be regions of the same size. The operation region is an example of the first region.

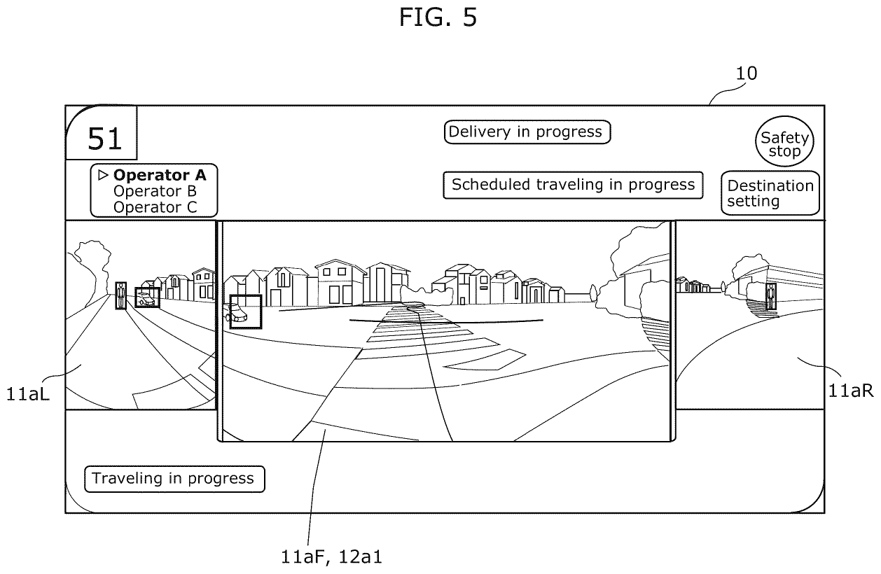

FIG. 5 is a diagram illustrating a display example of terminal 10 according to the present embodiment. FIG. 5 illustrates a display example in a case where the moving direction of mobile body 40 is the forward direction. Note that FIG. 5 illustrates the example in which three videos, i.e., forward direction video 11aF, right direction video 11aR, and left direction video 11aL, are displayed, but the number of videos to be displayed is not limited to three. For example, a rear direction video may be displayed. In addition, the number of the videos to be displayed may be set in advance, or may be set by the operator.

As illustrated in FIG. 5, output device 11 of terminal 10 displays various information including the videos. Output device 11 displays, in addition to videos 11aF, 11aR, and 11aL, a mobile body ID (for example, 51 in FIG. 5), the information specifying operators (for example, operators A to C in FIG. 5), the traveling state (traveling in progress or scheduled traveling in progress in FIG. 5), the service state (delivery in progress in FIG. 5), a destination setting button (destination setting in FIG. 5), a safety stop button (safety stop in FIG. 5), and the like.

Video 11aF is the video that has captured the forward direction of mobile body 40, video 11aR is the video that has captured the right direction of mobile body 40, and video 11aF is the video that has captured the left direction of mobile body 40. Video 11aF is an example of the front-camera video.

In step S11, video display 11a displays, for example, videos 11aL and 11aR in addition to video 11aF.

In the case of FIG. 5, the touch panel included in video display input receiver 12a is configured so as to cover at least the entire region of video 11aF. When video 11aF is displayed, video display input receiver 12a switches the detection of the touch operation on the entire region of video 11aF from OFF to ON. That is, video display input receiver 12a enables the detection of the touch operation on video 11aF.

Video 11aF is displayed for the operator to remotely monitor mobile body 40, and normally, the touch operation is not performed on video 11aF (the detection of the touch operation is not performed), but in the present disclosure, from a viewpoint of improving the operativity of the touch operation, the touch operation on video 11aF is detected.

Accordingly, since the display region of video 11aF can be used as operation region 12a1 of an operation button, operation region 12a1 can be increased without reducing the size of video 11aF. Operation region 12a1 is a touch area that receives the touch operation by the operator.

Note that, in the case of FIG. 5, the touch panel included in video display input receiver 12a may be configured to cover, for example, videos 11aF, 11aL, and 11aR. In this case, for example, when videos 11aL and 11aR are displayed, video display input receiver 12a may switch the detection of the touch operation on the entire regions of videos 11al and 11aR from OFF to ON, or may maintain the detection of the touch operation on the entire regions of videos 11aL and 11aR to be OFF.

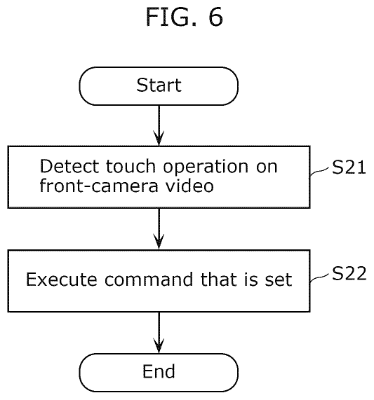

FIG. 6 is a flowchart illustrating the execution operation (remote monitoring method) of terminal 10 according to the present embodiment. The operation illustrated in FIG. 6 is executed by terminal 10.

As illustrates in FIG. 6, when video display input receiver 12a detects the touch operation on video 11aF (S21), execution command manager 13a executes the processing for executing the command that is set to video 11aF (S22). Execution command manager 13a transmits the command according to operation region 12a1 to mobile body 40 via control server 20. Accordingly, it is possible to cause mobile body 40 to execute the traveling operation according to the command operated by the operator.

Note that, in the present embodiment, one command is associated with operation region 12a1. No matter which position in operation region 12a1 the touch operation is performed, the same command is executed.

### Variation 1 of Embodiment

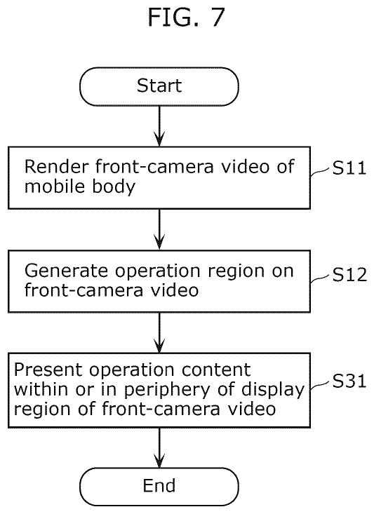

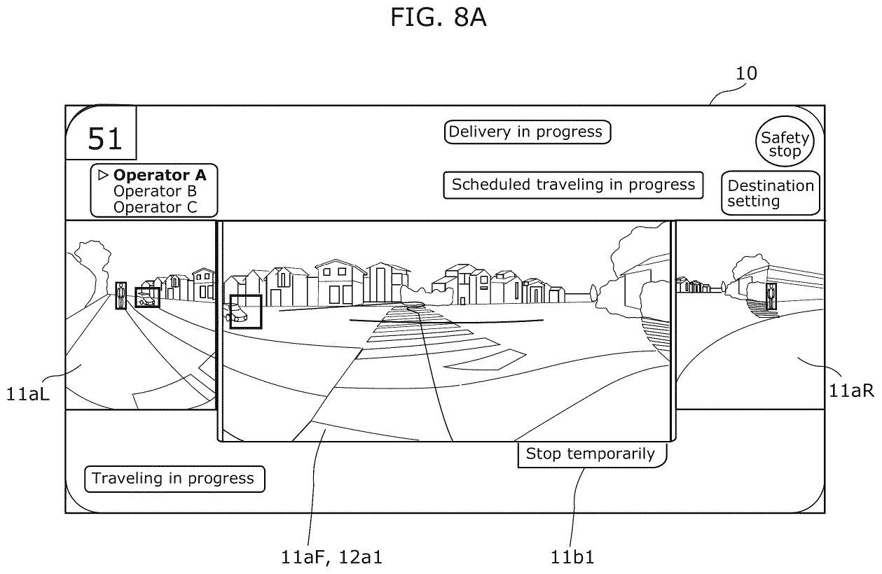

Hereinafter, referring to FIG. 7 to FIG. 8B, a remote monitoring method and the like according to the present variation will be described. Note that, hereinafter, differences from the embodiment will be mainly described, and a description of contents that are the same as or similar to the embodiment will be omitted or simplified. Note that, in each of Variation 1 and subsequent variations of the embodiment, the configuration of each component of a remote monitoring system may be the same as that of remote monitoring system 1 according to the embodiment, and will be described by using the numerals used in the embodiment.

In the present variation, a description will be given of an example of displaying the command that is executed when a touch operation is performed on the operation region. FIG. 7 is a flowchart illustrating the display operation (remote monitoring method) of terminal 10 according to the present variation.

As illustrated in FIG. 7, when the operation region is generated on the front-camera video by video display input receiver 12a (S12), operation content display 11b of terminal 10 presents the operation content within or in the periphery of the display region of the front-camera video (S31). Operation content display 11b presents, within or in the periphery of the display region, the information indicating the command that is set to the display region of the front-camera video.

FIG. 8A and FIG. 8B are diagrams each illustrating a display example of terminal 10 according to the present variation. FIG. 8A illustrates the example of presenting operation content 11b1 in the periphery of the display region, and FIG. 8B illustrates the example of presenting operation content 11b1 within the display region. FIG. 8A and FIG. 8B illustrate stop temporarily as an example of operation content 11b1.

As illustrated in FIG. 8A, operation content display 11b may present operation content 11b1 in the periphery of the display region of video 11aF. Operation content display 11b presents operation content 11b1 at a position that does not overlap with video 11aF. Accordingly, operation content 11b1 can be presented without blocking a part of video 11aF. In addition, for example, video display input receiver 12a may enable the detection of the touch operation on the region in which operation content 11b1 is presented.

As illustrated in FIG. 8B, operation content display 11b may present operation content 11b1 within the display region of video 11aF. Operation content display 11b displays operation content 11b1 superimposed on video 11aF. Operation content display 11b superimposes operation content 11b1 on a region within the display region considered to have few obstacles. When mobile body 40 is a vehicle, operation content display 11b superimposes operation content 11b1 on a region that displays not the vicinity of a road but the sky.

Accordingly, operation content 11b1 can be presented without blocking a part of video 11aF. In addition, for example, even when other information or the like is presented in the periphery of the display region of video 11aF, and it is difficult to present operation content 11b1, video display input receiver 12a can present operation content 11b1.

### Variation 2 of Embodiment

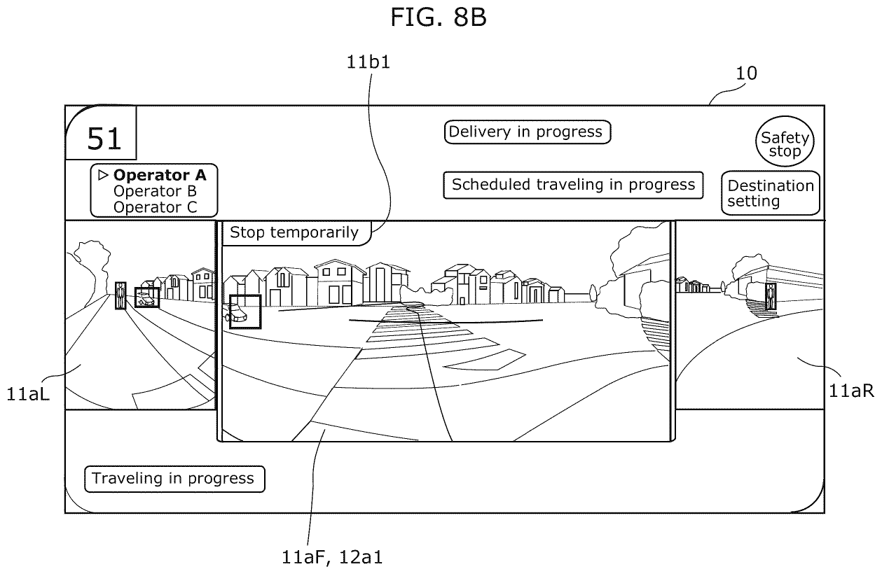

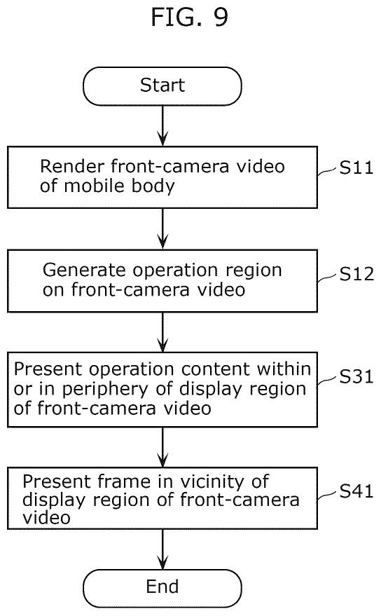

Hereinafter, referring to FIG. 9 and FIG. 10, a remote monitoring method and the like according to the present variation will be described. In the present variation, an example of presenting a frame that indicates the operation region will be described. FIG. 9 is a flowchart illustrating the display operation (remote monitoring method) of terminal 10 according to the present variation.

As illustrated in FIG. 9, when operation content 11b1 is presented by operation content display 11b (S31), video outer frame renderer 11c presents a frame in the vicinity of the display region of front-camera video (S41). Video outer frame renderer 11c presents the frame for clearly indicating the operation region on video 11aF. The frame is, for example, a frame for distinguishing the operation region on video 11aF from the other non-operation region of the display region of the display of terminal 10.

FIG. 10 is a diagram illustrating a display example of terminal 10 according to the present variation.

As illustrated in FIG. 10, video outer frame renderer 11c presents frame 11c1 surrounding video 11aF. Frame 11c1 may be presented in the same display style as operation content 11b1. For example, frame 11c1 may be presented in the same color as operation content 11b1. In addition, frame 11c1 is not limited to be annular, and may be in the shape of a frame that is partially interrupted, such as a broken line.

Accordingly, it is possible to make it explicitly known that the command indicated by operation content 11b1 is executed when the touch operation is performed on the display region of video 11aF. For example, the operator can easily know what command is to be executed by performing a touch operation within frame 11c1, by checking operation content 11b1 and frame 11c1. Therefore, according to remote monitoring system 1, the operativity of the touch operation can be improved compared with the case where such display is not performed.

Note that step S31 need not be performed in FIG. 9. That is, of operation content 11b1 and frame 11c1, only frame 11c1 may be presented.

### Variation 3 of Embodiment

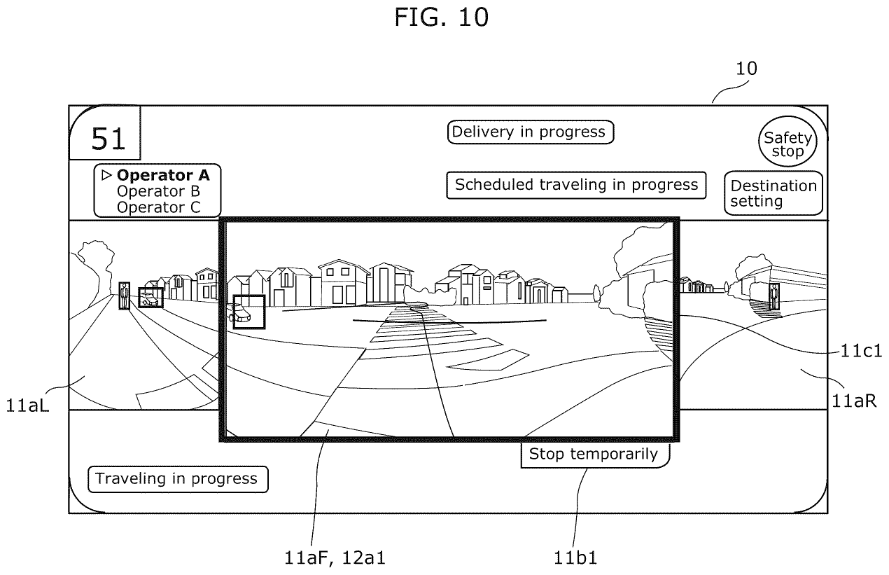

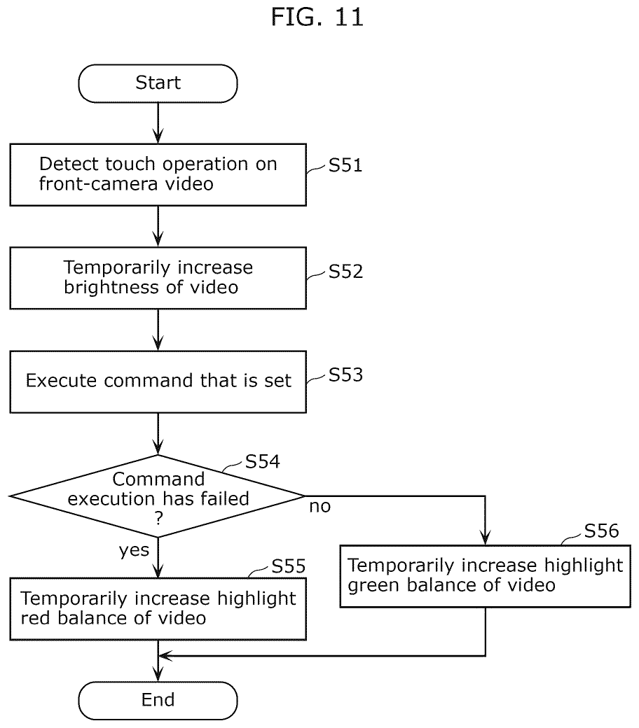

Hereinafter, referring to FIG. 11 and FIG. 12, a remote monitoring method and the like according to the present variation will be described. In the present variation, a description will be given of the remote monitoring method capable of intuitively informing the operator that a touch operation is received when the operator performs the touch operation on video 11aF. FIG. 11 is a flowchart illustrating the operation (remote monitoring method) of terminal 10 according to the present variation. FIG. 12 is a diagram illustrating a display example of terminal 10 according to the present variation.

As illustrated in FIG. 11, when the operator performs a touch operation on the display region of video 11aF, video display input receiver 12a detects the touch operation on video 11aF (S51).

Next, when the touch operation is detected by video display input receiver 12a, video display 11a temporarily increases the brightness of video 11aF to notify the operator of the detection (S52). Accordingly, it is possible to visually inform the operator that the touch operation is received. Note that when the touch operation is detected, it is not limited to changing the brightness, and it suffices if some kind of display style is changed. For example, the display style (for example, the color, blinking, or the like) of at least one of operation content 11b1 or frame 11c1 may be changed.

In (a) in FIG. 12, it is illustrated with broken lines that the brightness of video 11aF is temporarily increased.

Referring again to FIG. 11, next, execution command manager 13a performs the processing for executing the command that is set to video 11aF (S53). Execution command manager 13a transmits the command corresponding to operation content 11b1 to mobile body 40 via control server 20. In the example of FIG. 12, the command for temporarily stopping mobile body 40 is transmitted to mobile body 40.

Next, execution command manager 13a determines whether or not the command executed in step S53 has failed in mobile body 40 (S54). When execution command manager 13a receives the information indicating the completion of the execution of the command from mobile body 40, execution command manager 13a determines that the command has not failed, and when execution command manager 13a does not receive the information indicating the completion of the execution of the command from mobile body 40 within a predetermined period, or when execution command manager 13a receives the information indicating that the execution of the command has failed from mobile body 40, execution command manager 13a determines that the command has failed.

When execution command manager 13a determines that the command execution has failed (yes in S54), video display 11a temporarily increases the highlight red balance of video 11aF to notify the operator of the failure (S55). In addition, when execution command manager 13a determines that the command execution has not failed (no in S54), video display 11a temporarily increases the highlight green balance of video 11aF to notify the operator of the success (S56).

In (b) and (c) in FIG. 12, changing the balance of the highlight of video 11aF is illustrated by changing the style of hatching.

In this manner, when terminal 10 receives the touch operation, terminal 10 notifies the operator of the case where the command execution has been successful and the case where the command execution has failed with mutually different display styles. Note that the display styles are not limited to the display styles described above, as long as the display styles are different from each other in the three cases. For example, in the three cases, the display style of at least one of the frame or the operation content may be changed. Terminal 10 may change the display style of at least one of the frame or the operation content according to, for example, the execution state of the command corresponding to the received touch operation.

### Variation 4 of Embodiment

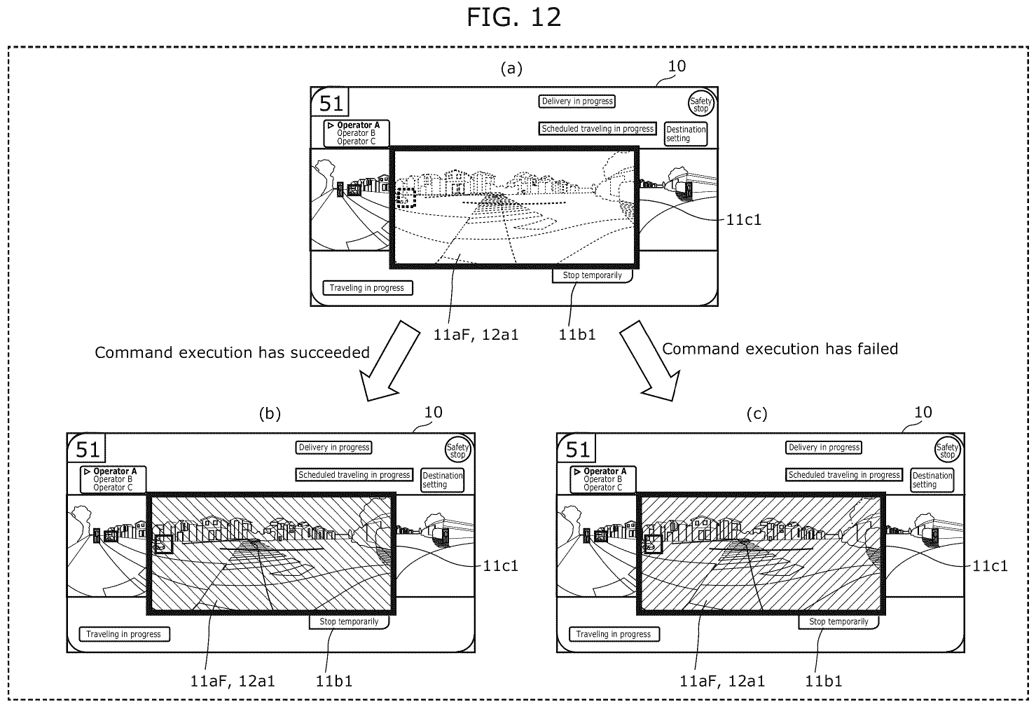

Hereinafter, referring to FIG. 13 to FIG. 15, a remote monitoring method and the like according to the present variation will be described. In the present variation, a description will be given of an example of changing the display style of a video and the command to be executed, according to the operation type of a touch operation. FIG. 13 is a flowchart illustrating the operation (remote monitoring method) of terminal 10 according to the present variation.

As illustrated in FIG. 13, when the touch operation on the front-camera video is detected by video display input receiver 12a (S51), execution command manager 13a detects the operation type and determines the execution command (command) (S61). Execution command manager 13a performs the determination in step S61 based on the table showing the relationship between the operation type and the execution command.

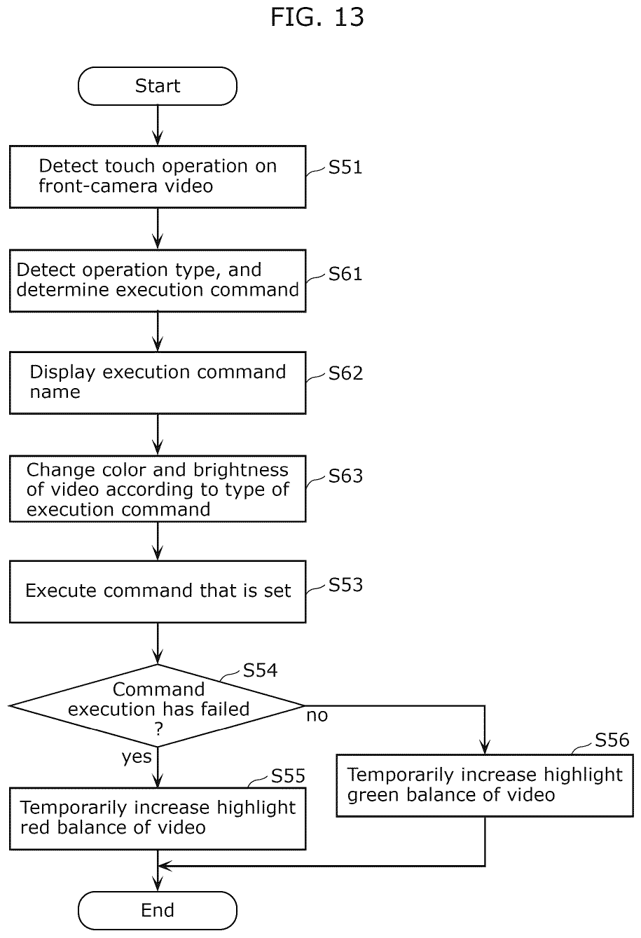

FIG. 14 is a table showing the relationship between the operation type of the touch operation, the display style of the video, and the execution command according to the present variation. The table illustrated in FIG. 14 is created in advance, and is stored in the storage of terminal 10.

As illustrated in FIG. 14, in the table, the operation type of the touch operation, the change of the display style of the video at the time of the operation, and the execution command are associated with each other. For example, when a tap is performed as a touch operation, the brightness of the video is increased and decreased three times, and stop traveling is performed as the execution command. In addition, when a long tap is performed, the brightness is gradually increased, and start call is performed as the execution command.

Note that the example of changing only the brightness is illustrated in the change of the display style of the video at the time of the operation, the color of the video may be changed in addition to the brightness or instead of the brightness.

Note that the combinations of the operation type, the change of the display style of the video at the time of the operation, and the execution command are not limited to the combinations illustrated to FIG. 14, and may be other combinations. Furthermore, the display style of at least one of the operation content or the frame may be changed together with the display style of the video or in addition to the display style of the video.

Referring again to FIG. 13, operation content display 11b displays an execution command name within or in the periphery of the display region of the video (S62). Operation content display 11b displays the execution command name determined in step S61.

Next, video display 11a changes the color and brightness of the video according to the type of the execution command (S63). Video display 11a changes the color and brightness of the video to the content shown in the item of the change of the display style of the video at the time of the operation illustrated in FIG. 14. Note that, in step S63, it suffices if at least one of the color or brightness of the video is changed.

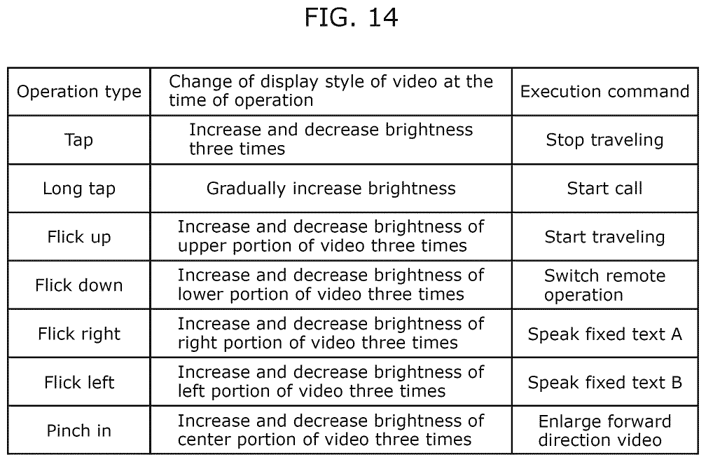

FIG. 15 is a diagram illustrating a display example of terminal 10 according to the present variation. What is written in < > illustrated in FIG. 15 indicates the operation type. In FIG. 15, the portions in which the display style of the video has been changed before a touch operation is performed are indicated by diagonal hatching.

As illustrated in FIG. 15, when a touch operation is performed, at least one of the color or brightness is changed in mutually different display styles according to the operation type. Here, the display styles being different includes that the regions in which the display style is changed are different. In addition, the command (operation content 11b1) to be executed according to the operation type is also changed.

Referring again to FIG. 13, the processing in step S53 and subsequent steps is continued.

In this manner, the plurality of operation types exist for the touch operation, and terminal 10 makes the display style of video 11aF and the command to be executed different according to the operation type of the touch operation performed on the display region of video 11aF.

### Variation 5 of Embodiment

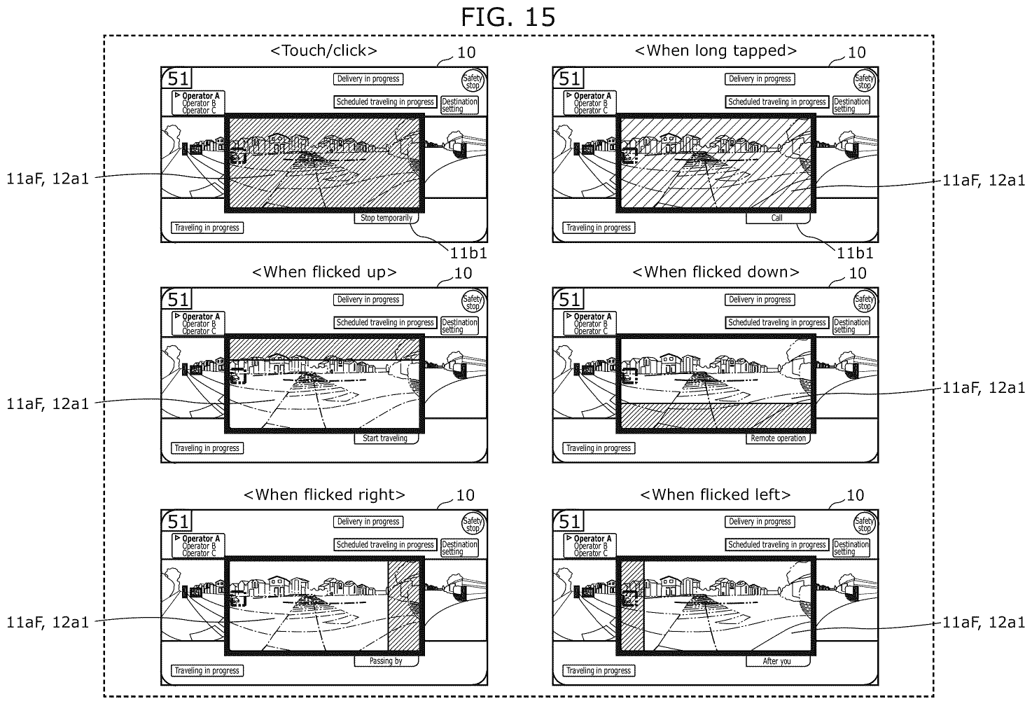

Hereinafter, referring to FIG. 16 to FIG. 19, a remote monitoring method and the like according to the present variation will be described. In the present variation, a description will be given of an example in which, according to the state of mobile body 40, when a command cannot be executed, the command is deactivated. FIG. 16 is a flowchart illustrating the operation (remote monitoring method) of terminal 10 according to the present variation.

As illustrated in FIG. 16, execution command manager 13a of terminal 10 obtains the vehicle state from mobile body 40 (S71). Execution command manager 13a may, for example, regularly obtain the vehicle state. In addition, execution command manager 13a manages the vehicle state of each mobile body 40. The vehicle state is an example of the state of mobile body 40.

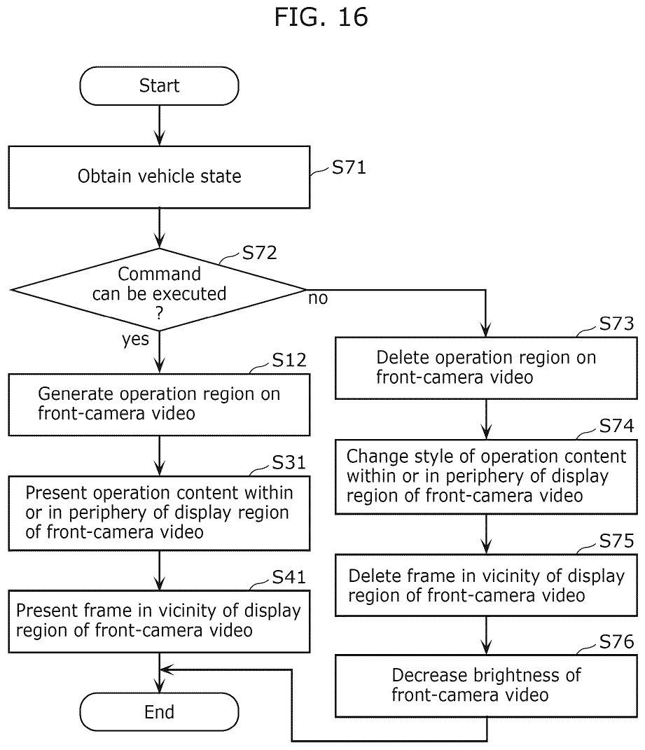

FIG. 17 is a diagram illustrating an example of the vehicle state according to the present variation.

As illustrated in FIG. 17, the vehicle state indicates the state related to movement of mobile body 40, and includes, for example, traveling in progress, stopped, remote operation in progress, manual operation in progress, stopped due to emergency, failure has occurred, and offline. In addition, execution command manager 13a stores the mobile body ID of each mobile body 40 in association with the vehicle state.

Referring again to FIG. 16, execution command manager 13a determines whether or not a command can be executed in mobile body 40, based on the vehicle state (S72).

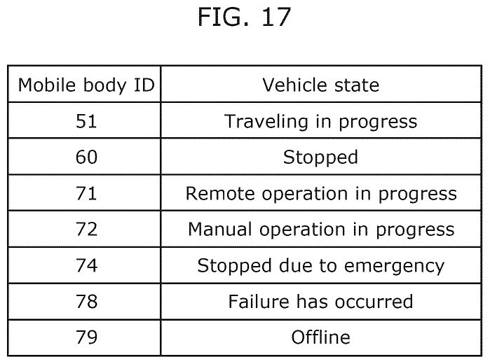

FIG. 18 is a flowchart illustrating an example of step S72 illustrated in FIG. 16.

As illustrated in FIG. 18, execution command manager 13a determines whether or not the vehicle state is in a predetermined state. In the example of FIG. 18, execution command manager 13a determines whether or not the vehicle state of mobile body 40 is traveling in progress (for example, autonomous traveling in progress) (S72a). In the case of FIG. 17, execution command manager 13a determines that mobile body 40 with a mobile body ID of 51 is traveling in progress, and determines that the other mobile bodies 40 are not traveling in progress.

Next, when execution command manager 13a determines that the vehicle state is traveling in progress (yes in S72a), execution command manager 13a determines that a stop temporarily command can be executed (S72b), and when execution command manager 13a determines that the vehicle state is not traveling in progress (no in S72a), execution command manager 13a determines that a stop temporarily command cannot be executed (S72c). Execution command manager 13a may perform step S72 based on a table (not illustrated) in which the vehicle state and the executable command are associated with each other.

Referring again to FIG. 16, when the command can be executed (yes in S72), terminal 10 executes the processing in step S12 and subsequent steps, and when the command cannot be executed (no in S72), terminal 10 executes the processing in step S73 and subsequent steps. The processing in step S73 and the subsequent steps illustrates the operation in the case where the state in which the command can be executed transitions to the state in which the command cannot be executed.

Next, video display input receiver 12a deletes the operation region on the front-camera video (S73). Video display input receiver 12a disables the detection of the touch operation in the operation region on the front-camera video.

Next, operation content display 11b changes the style of the operation content within or in the periphery of the display region of the front-camera video (S74). Operation content display 11b changes the style into a style from which it can be known that the command is deactivated. Operation content display 11b may darkly display the operation content.

Next, video outer frame renderer 11c deletes the frame in the vicinity of the display region of the front-camera video (S75). Accordingly, it is possible to intuitively inform the user that the operation region has been deleted in step S73.

Next, video display 11a decreases the brightness of the front-camera video (S76). By decreasing the brightness, it is possible to effectively inform the operator that the command is deactivated.

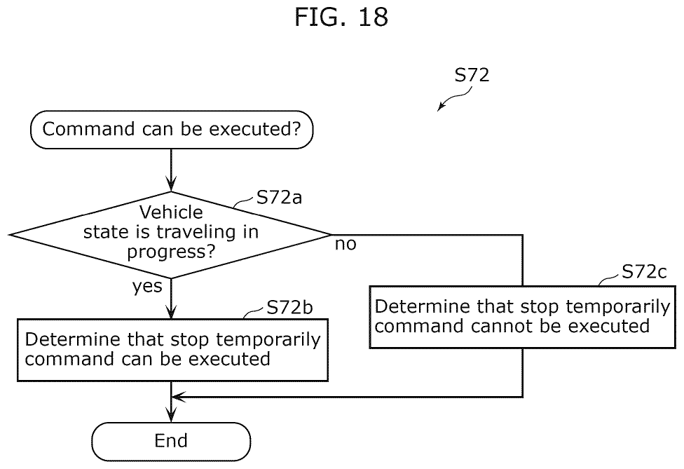

FIG. 19 is a diagram illustrating a display example of terminal 10 according to the present variation. FIG. 19 illustrates a display example in a case where the display illustrated in FIG. 10 has transitioned to the state in which the command is deactivated. In addition, FIG. 19 illustrates a display example in a case where the vehicle state is stopped.

As illustrated in FIG. 10 and FIG. 19, when the transition to the state in which the command is deactivated is performed, frame 11c1 is deleted, operation region 12a1 is deleted, and operation content 11b1 is darkly displayed.

As described above, when the command cannot be executed, terminal 10 may deactivate the command, and change the display style of at least one of the frame, the operation content, or the video. Deactivating the command means disabling the detection of the touch operation in the operation region corresponding to the command.

In addition, terminal 10 is capable of switching between enabling and disabling of the detection of the touch operation on the display region of video 11aF, based on the vehicle state. In addition, operation content display 11b may make the display style of the display of the command different, depending on whether the detection of the touch operation on the display region of video 11aF is enabled or disabled. Furthermore, video outer frame renderer 11c may make the display style of frame 11c1 different, depending on whether the detection of the touch operation on the display region of video 11aF is enabled or disabled. In addition, video display 11a may make the display style of video 11aF different, depending on whether the detection of the touch operation on the display region of video 11aF is enabled or disabled.

### Variation 6 of Embodiment

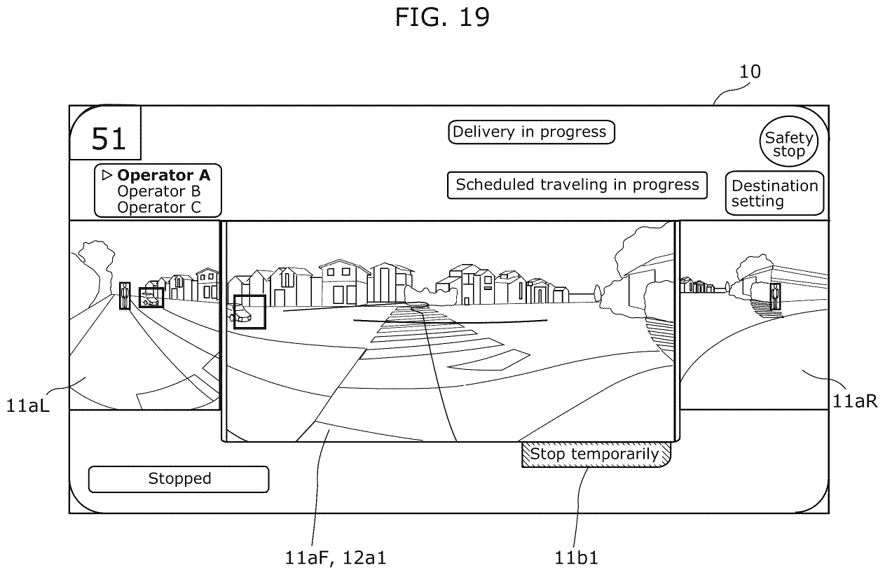

Hereinafter, referring to FIG. 20 to FIG. 22, a remote monitoring method and the like according to the present variation will be described. In the present variation, a description will be given of an example of changing the command to be executed, according to the state of mobile body 40. FIG. 20 is a flowchart illustrating the operation (remote monitoring method) of terminal 10 according to the present variation.

As illustrated in FIG. 20, when execution command manager 13a obtains the vehicle state of mobile body 40 (S71), execution command manager 13a determines whether or not the vehicle state has changed (S81). Execution command manager 13a may perform the determination in step S81 by whether or not the most recently obtained vehicle state of mobile body 40 matches the vehicle state of mobile body 40 newly obtained in step S71.

Next, when execution command manager 13a determines that the vehicle state has changed (yes in S81), execution command manager 13a determines the execution command according to the vehicle state after the change (S82). It can be said that execution command manager 13a automatically updates the execution command based on the change in the vehicle state. Execution command manager 13a performs the determination in step S82 based on the table showing the relationship between the vehicle state and the execution command. In addition, when execution command manager 13a determines that the vehicle state has not changed (no in S81), execution command manager 13a ends the processing.

FIG. 21 is a table showing the relationship between the vehicle state and the execution command according to the present variation. The table illustrated in FIG. 21 is created in advance, and is stored in the storage of terminal 10.

As illustrated in FIG. 21, in the table, the vehicle state and the execution command at that time are associated with each other. The vehicle state “traveling in progress” is associated with “stop temporarily”, “stopped” is associated with “start traveling”, and “stopped due to emergency” is associated with “release emergency stop.” Note that “−” indicates that there is no command that can be executed by the operator.

Referring again to FIG. 20, next, operation content display 11b changes the execution command in the operation region on the front-camera video to the execution command determined in step S82 (S83). Operation content display 11b switches the command associated with the operation region, based on the state of mobile body 40. It can be said that operation content display 11b updates the operation content of the execution command in the operation region.

Next, operation content display 11b changes the presentation style of the operation content according to the type of the execution command (S84). Operation content display 11b changes the presentation style of the operation content based on, for example, the table in which the presentation style of the operation content and the type of the execution command are associated with each other. Accordingly, it is possible to notify the operator that the operation content has been changed, by changing the presentation style of the operation content.

Next, video outer frame renderer 11c changes the presentation style of the frame in the vicinity of the display region of the video according to the type of the execution command (S85). Video outer frame renderer 11c changes the presentation style of the frame based on, for example, the table in which the presentation style of the frame and the type of the execution command are associated with each other. Accordingly, it is possible to notify the operator that the operation content has been changed, by changing the presentation style of the frame.

Note that only one of steps S84 and S85 may be executed.

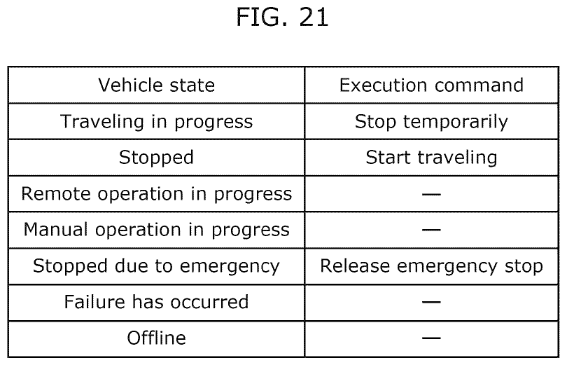

FIG. 22 is a diagram illustrating a display example of terminal 10 according to the present variation. (a) in FIG. 22 illustrates a display example in the case of the vehicle state before the change (traveling in progress), and (b) in FIG. 22 illustrates a display example in the case of the vehicle state after the change (stopped).

When the vehicle state of mobile body 40 is switched from traveling in progress to stopped, the display style of the frame is changed from frame 11c1 to frame 11c2, and the display style of the operation content is changed from operation content 11b1 to operation content 11b2.

As described above, when the command to be executed is changed, the display style of at least one of the frame or the operation content may be changed.

### Variation 7 of Embodiment

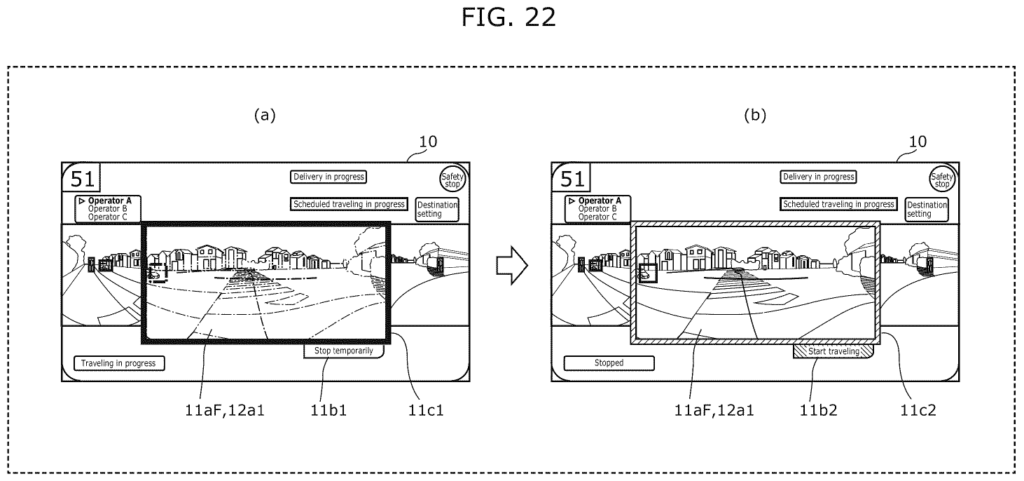

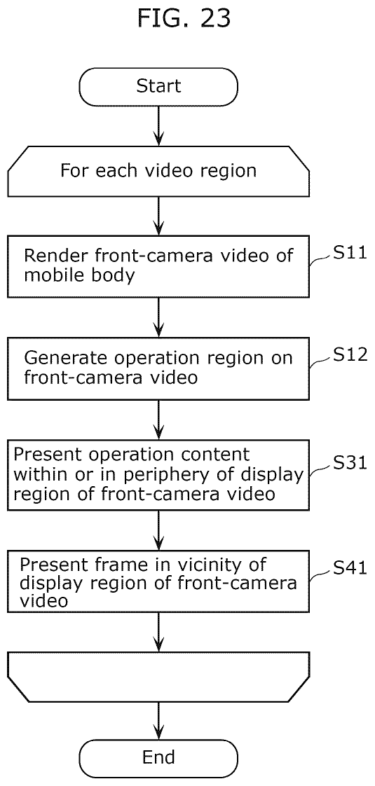

Hereinafter, referring to FIG. 23 and FIG. 24, a remote monitoring method and the like according to the present variation will be described. In the present variation, a description will be given of an example of assigning a command execution function to a video other than the front. FIG. 23 is a flowchart illustrating the operation (remote monitoring method) of terminal 10 according to the present variation. FIG. 24 is a diagram illustrating a display example of terminal 10 according to the present variation.

As illustrated in FIG. 23, the processing illustrated in FIG. 9 is executed for each video region. In the case of FIG. 24, the processing illustrated in FIG. 9 is executed for each of videos 11aF, 11aR, and 11aL. For example, mutually different commands may be set to videos 11aF, 11aR, and 11aL, respectively, according to the vehicle state.

In the example of FIG. 24, the example is illustrated in which fixed text speak commands are assigned to the left- and right-camera videos. Specifically, FIG. 24 illustrates the example in which operation region 12a1 for video 11aF is generated, operation region 12a2 for video 11aL is generated, and operation region 12a3 for video 11aR is generated. In addition, FIG. 24 illustrates the example in which operation content 11b1 for video 11aF is stop temporarily, operation content 11b3 for video 11aL is to speak “passing by”, and operation content 11b4 for video 11aR is to speak “after you.” In addition, FIG. 24 illustrates the example in which frame 11c1 for operation region 12a1 is presented, frame 11c3 for operation region 12a2 is presented, and frame 11c4 for operation region 12a3 is presented.

Accordingly, for example, when a touch operation is performed on operation region 12a2, “passing by” is spoken from mobile body 40 to the outside of mobile body 40, and when a touch operation is performed on operation region 12a3, “after you” is spoken from mobile body 40 to the outside of mobile body 40.

### Variation 8 of Embodiment

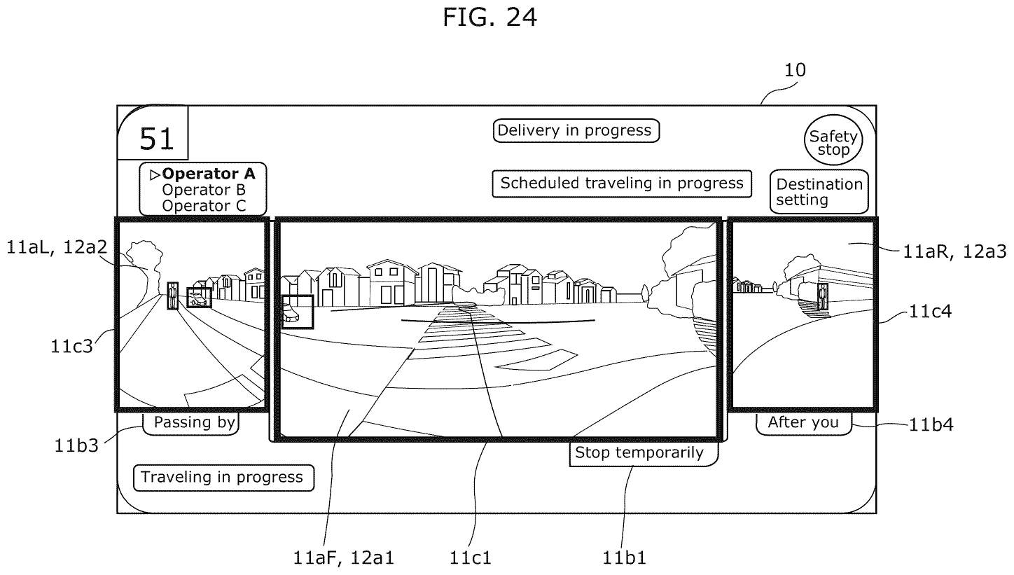

Hereinafter, referring to FIG. 25 to FIG. 28, a remote monitoring method and the like according to the present variation will be described. In the present variation, a description will be given of an example of changing the video assignment destination of a command, according to the moving direction. FIG. 25 is a flowchart illustrating the operation (remote monitoring method) of terminal 10 according to the present variation.

As illustrated in FIG. 25, terminal 10 obtains the route information of mobile body 40 to be remotely monitored (S91). Terminal 10 obtains, for example, the information, such as destination setting and travel route setting, which is input by the user of mobile body 40 to a navigation device mounted on mobile body 40 or to a mobile terminal such as a smartphone.

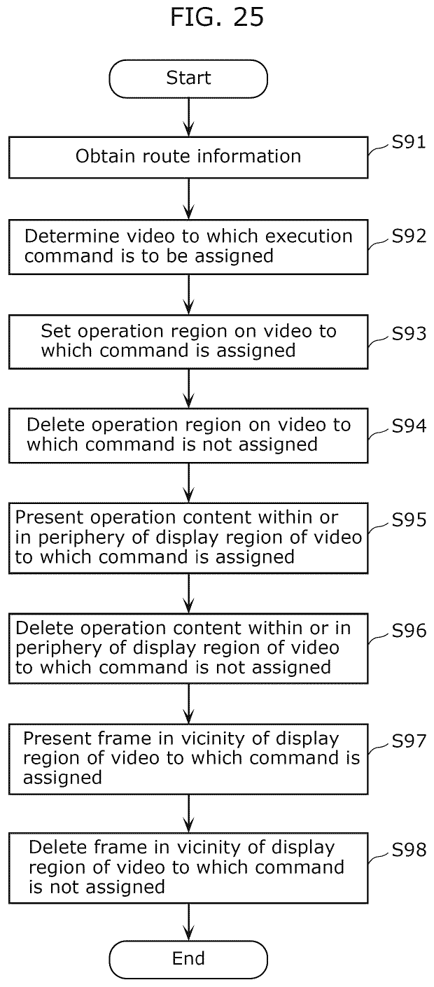

FIG. 26 is a diagram illustrating an example of route information according to the present variation.

As illustrated in FIG. 26, the route information indicates the next behavior of each mobile body 40 that travels autonomously. The next behavior indicates how mobile body 40 is to travel next at the current time. For example, it can be seen that, in the case of the mobile body with a mobile body ID of 51, the mobile body is scheduled to make a right turn next, and in the case of the mobile body with a mobile body ID of 60, the mobile body is scheduled to move forward next.

Such route information can be specified based on, for example, the destination that is set, the travel route to the destination, the current position of mobile body 40, map information, and the like.

Referring again to FIG. 25, next, execution command manager 13a determines the video to which an execution command is to be assigned, based on the route information (S92). Execution command manager 13a performs the determination in step S92 based on the table in which the route and the video to which the execution command is to be assigned are associated with each other.

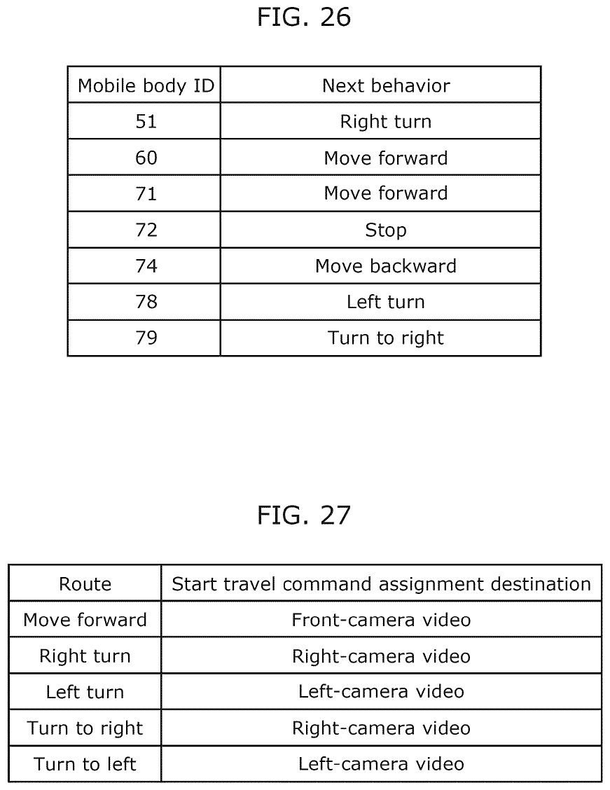

FIG. 27 is a table showing the relationship between the route and the command assignment destination according to the present variation. The table illustrated in FIG. 27 is created in advance, and is stored in the storage of terminal 10. FIG. 27 illustrates an example in which the command is a start traveling command. For example, the table illustrated in FIG. 27 may be created for each command. In addition, it is assumed that the table illustrated in FIG. 27 is a state in which mobile body 40 is currently stopped, and mobile body 40 starts traveling when the operator performs the touch operation for executing the start traveling command.

As illustrated in FIG. 27, in the table, the route and the start traveling command assignment destination are associated with each other. The route indicates the current moving direction of mobile body 40. Move forward indicates that mobile body 40 is scheduled to move forward from the current position. In addition, right turn indicates that mobile body 40 is scheduled to make a right turn from the current position.

For example, in the case of the mobile body with a mobile body ID of 51, the assignment destination of the start traveling command is determined to be a right-camera video. In addition, in the case of the mobile body with a mobile body ID of 60, the assignment destination of the start traveling command is determined to be the front-camera video. In this manner, the camera video to which the operator should pay more attention is determined to be the assignment destination of the start traveling command, according to the next behavior of mobile body 40.

Referring again to FIG. 25, next, video display input receiver 12a sets an operation region on the video to which the command is assigned (S93). Video display input receiver 12a enables the detection of the touch operation on the region (operation region) of the touch panel that overlaps with the video to which the command is assigned.

Next, video display input receiver 12a deletes the operation region on the video to which the command is not assigned (S94). When an operation region is set to the video other than the video determined in step S92, video display input receiver 12a deletes the region. Video display input receiver 12a disables the detection of the touch operation on the region (the operation region on the video to which the command is not assigned) of the touch panel that does not overlap with the video to which the command is assigned.

Next, operation content display 11b presents the operation content within or in the periphery of the display region of the video to which the command is assigned (S95).

Next, operation content display 11b deletes the operation content within or in the periphery of the display region of the video to which the command is not assigned (S96). When an operation content for the video other than the video determined in step S92 is presented, operation content display 11b deletes the operation content.

Next, video outer frame renderer 11c presents a frame in the vicinity of the display region of the video to which the command is assigned (S97). Video outer frame renderer 11c presents, for example, the frame surrounding the video.

Next, video outer frame renderer 11c deletes a frame in the vicinity of the display region of the video to which the command is not assigned (S98). When a frame for the video other than the video determined in step S92 is presented, video outer frame renderer 11c deletes the frame.

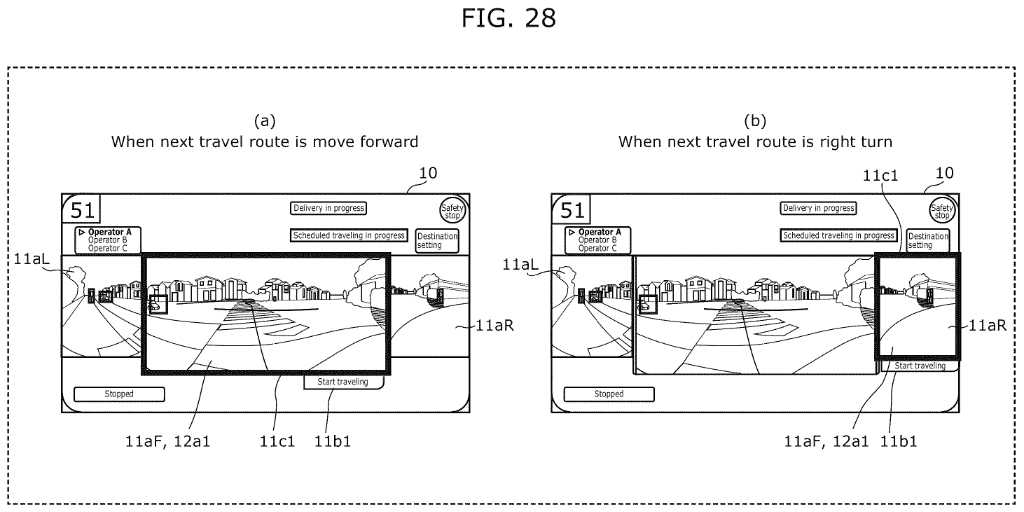

FIG. 28 is a diagram illustrating a display example of terminal 10 according to the present variation. FIG. 28 illustrates a display example in a case where the vehicle state is stopped.
(a) in FIG. 28 illustrates the display at the time when the next travel route is moving forward, and operation region 12a1, operation content 11b1, and frame 11c1 are provided in the front-camera video (video 11aF) associated with move forward.

In the case of (a) in FIG. 28, video 11aF is the video that has captured the forward direction (an example of the first direction) in which mobile body 40 is capable of moving, and videos 11aL and 11aR are the videos that have captured the right and left directions (examples of the second direction) in which mobile body 40 is capable of moving, and that are displayed in regions different from the display region of video 11aF.
(b) in FIG. 28 illustrates the display at the time when the next travel route is a right turn, and operation region 12a1, operation content 11b1, and frame 11c1 are provided in the right-camera video (video 11aR) associated with a right turn.

In this manner, since it is considered that the operator will inevitably focus on the destination to be headed to next, the operation region, the operation content, and the frame are provided to the video that the operator is considered to focus on.

In the case of (b) in FIG. 28, video 11aR is the video that has captured the right-turn direction (an example of the first direction) in which mobile body 40 is capable of moving, and videos 11aL and 11aF are the videos that have captured the forward or left-turn direction (an example of the second direction) in which mobile body 40 is capable of moving, and that are displayed in regions different from the display region of video 11aR.

Note that, in FIG. 25, it suffices if at least steps S91 to S93 are executed.

### OTHER EMBODIMENTS

Although the remote monitoring method and so on according to one or more aspects have been described above based on an embodiment and the like, the present disclosure is not limited to the embodiment and the like. The present disclosure may also include forms achieved by making various modifications to the embodiment that can be conceived by those skilled in the art, as well as forms achieved by combining constituent elements in different embodiments, without materially departing from the spirit of the present disclosure.

For example, in the above-described embodiment and the like, terminal 10 may include a display, or may be communicatively connected to an external display.

In the above embodiment and the like, each of the constituent elements may be configured in the form of an exclusive hardware product, or may be implemented by executing a software program suitable for the constituent element. Each of the constituent elements may be implemented by a program executor, such as a central processing unit (CPU) or a processor, reading and executing the software program recorded on a recording medium such as a hard disk or semiconductor memory.

The processing order of executing the steps shown in the flowcharts is a mere illustration for specifically describing the present disclosure, and thus may be an order other than the shown order. Also, one or more of the steps may be executed simultaneously (in parallel) with another step, or may be steps that are not executed.

The divisions of the functional blocks shown in the block diagrams are mere examples, and thus a plurality of functional blocks may be implemented as a single functional block, or a single functional block may be divided into a plurality of functional blocks, or one or more functions may be moved to another functional block. Also, the functions of a plurality of functional blocks having similar functions may be processed by a single hardware or software product in a parallelized or time-divided manner.

Terminal 10 according to the above embodiment and the like may be implemented as a single device or may be implemented by a plurality of devices. When terminal 10 is implemented by a plurality of devices, the constituent elements included in terminal 10 may be assigned to the plurality of devices in any manner. When terminal 10 is implemented by a plurality of devices, the method of communication between the plurality of devices is not particularly limited. The communication may be wireless communication or may be wired communication. Wireless communication and wired communication may be combined for communication between the devices.

Each of the constituent elements described in the above embodiments and the like may be implemented in the form of a software product, or may be typically implemented as a large-scale integrated (LSI) circuit, which is an integrated circuit (IC). These may take the form of individual chips, or may be partially or entirely packaged into a single chip. Although the term “LSI” is used here, other names, such as IC, system LSI, super LSI, and ultra LSI may be used, depending on the level of integration. Furthermore, the manner in which the circuit integration is achieved is not limited to LSI, and it is also possible to use a dedicated circuit (a general-purpose circuit that executes a dedicated program) or a general-purpose processor. A field programmable gate array (FPGA) that allows for programming after the manufacture of an LSI circuit, or a reconfigurable processor that allows for reconfiguration of the connection and the setting of circuit cells inside an LSI circuit may be employed. Furthermore, when advancement in semiconductor technology or derivatives of other technologies brings forth a circuit integration technology which replaces LSI, it will be appreciated that such a circuit integration technology may be used to integrate the constituent elements.

A system LSI circuit is a super-multifunctional LSI circuit manufactured with a plurality of processing units integrated on a single chip, and is specifically a computer system including a microprocessor, read-only memory (ROM), and random-access memory (RAM), for example. A computer program is stored in the ROM. The system LSI circuit achieves its function as a result of the microprocessor operating according to the computer program.

An aspect of the present disclosure may be a computer program that causes a computer to execute each characteristic step included in the remote monitoring method illustrated in any one of FIG. 4, FIG. 6, FIG. 7, FIG. 9, FIG. 11, FIG. 13, FIG. 16, FIG. 18, FIG. 20, FIG. 23, or FIG. 25.

For example, the program may be a program to be executed by a computer. An aspect of the present disclosure may be a non-transitory computer-readable recording medium having such a program recorded thereon. For example, such a program may be recorded on a recording medium and distributed. For example, by installing the distributed program in a device that includes another processor and causing the processor to execute the program, it is possible to cause the device to perform each of the processes described above.

### INDUSTRIAL APPLICABILITY

The present disclosure is useful for a remote monitoring system and the like that remotely monitor a mobile body that is capable of moving autonomously.

1. A remote monitoring method for remotely monitoring a mobile body that travels autonomously, the remote monitoring method comprising:
displaying a first video that has captured a direction in which the mobile body is capable of moving; and
enabling detection of a touch operation on a first region in which the first video is displayed.

2. The remote monitoring method according to claim 1, further comprising:
displaying, in the first region or a vicinity of the first region, an operation content to be executed through the touch operation on the first region.

3. The remote monitoring method according to claim 1, further comprising:
displaying a frame surrounding the first region.

4. The remote monitoring method according to claim 3, further comprising:
displaying, in the first region or a vicinity of the first region, an operation content to be executed through the touch operation on the first region, wherein
the frame and the operation content are displayed in a same display style.

5. The remote monitoring method according to claim 4, wherein
the frame and the operation content are displayed in a same color.

6. The remote monitoring method according to claim 3, further comprising:
changing a display style of the frame when the touch operation on the first region is received.

7. The remote monitoring method according to claim 4, further comprising:
changing a display style of the frame according to an execution state of the operation content intended for the mobile body.

8. The remote monitoring method according to claim 4, wherein
the detection of the touch operation on the first region is switchable to be disabled, based on a state of the mobile body,
the remote monitoring method further comprising:
making a display style of the operation content different depending on whether the detection of the touch operation on the first region is enabled or disabled.

9. The remote monitoring method according to claim 3, wherein
the detection of the touch operation on the first region is switchable to be disabled, based on a state of the mobile body,
the remote monitoring method further comprising:
making a display style of the frame different depending on whether the detection of the touch operation on the first region is enabled or disabled.

10. The remote monitoring method according to claim 3, wherein
the detection of the touch operation on the first region is switchable to be disabled, based on a state of the mobile body,
the remote monitoring method further comprising:
making a display style of the first video different depending on whether the detection of the touch operation on the first region is enabled or disabled.

11. The remote monitoring method according to claim 1, further comprising:
switching an operation content associated with the first region, based on a state of the mobile body.

12. The remote monitoring method according to claim 1, further comprising:
changing a display style of the first video when the touch operation on the first region is detected.

13. The remote monitoring method according to claim 3, further comprising:
changing a display style of the frame when the touch operation on the first region is detected.

14. The remote monitoring method according to claim 1, further comprising:
changing a display style of the first video according to an execution state of remote monitoring of the mobile body.

15. The remote monitoring method according to claim 1, wherein
the first video is a video that has captured a first direction in which the mobile body is capable of moving,
the remote monitoring method further comprising:
displaying, in a second region different from the first region, a second video that has captured a second direction in which the mobile body is capable of moving;
obtaining route information on the mobile body; and
enabling detection of the touch operation on the first region when a moving direction of the mobile body based on the route information is the first direction.

16. The remote monitoring method according to claim 2, wherein
the touch operation includes a plurality of operation types,
the remote monitoring method further comprising:
making the operation content and a display style of the first video different according to an operation type of the touch operation executed on the first region.

17. A remote monitoring device that remotely monitors a mobile body that travels autonomously, the remote monitoring device comprising:
a first controller that controls displaying of a video that has captured a direction in which the mobile body is capable of moving; and
a second controller that enables detection of a touch operation on a region in which the video is displayed.

18. A non-transitory computer-readable recording medium having recorded thereon a program for causing a computer to execute the remote monitoring method according to claim 1.
